(19) United States
(12) Patent Application Publication
(10) Pub. No.: US 2014/0287923 A1
(43) Pub. Date: Sep. 25, 2014

(54) METHOD FOR ENHANCING CROP YIELDS BY APPLICATION OF TREHALOSE

(71) Applicant: Stoller Enterprises, Inc., Houston, TX (US)

(72) Inventors: Jerry H. Stoller, Houston, TX (US); Ronald Salzman, College Station, TX (US); Albert Liptay, Houston, TX (US)

(73) Assignee: Stoller Enterprises, Inc., Houston, TX (US)

(21) Appl. No.: 14/296,315

(22) Filed: Jun. 4, 2014

Related U.S. Application Data
(63) Continuation of application No. 13/614,741, filed on Sep. 13, 2012.

(51) Int. Cl. A01N 43/16; A01N 25/02

(52) U.S. Cl. CPC A01N 43/16; A01N 25/02
USPC 504/292

(57) ABSTRACT

A method for increasing and/or preserving yields and/or biomass in crop species including potatoes, beets, sugar cane, corn, soybeans and others by exogenous application of trehalose and/or trehalose derivatives at any time in the growing process such as before crop sowing, during sowing, or during plant establishment. The method, when applied early in crop production results in enhanced health and vigor of the mother plant resulting in healthier produce having reduced sugars from the mother plant

### CLAIM TO PRIORITY

This non-provisional application is a continuation of and claims priority from Non-Provisional application Ser. No. 13/614,741 filed on Sep. 13, 2012. This application also claims priority from Provisional Patent Application No. 61/533,872 filed on Sep. 13, 2011 and from Provisional Patent Application No. 61/538,653 filed Sep. 23, 2011. The Non-Provisional Application U.S. Ser. No. 13/614,741 is hereby incorporated by reference.

### BACKGROUND OF THE INVENTION

1. Field of the Invention

This invention relates to exogenous application of trehalose and/or trehalose derivatives to crop plants to signal enhanced transfer of photosynthates and derivatives of photosynthates, from the “mother” plant to the economic portion of crops such as seeds, tubers, fruits, etc.

(photosynthates are compounds formed by photosynthesis). Furthermore, the exogenous application can be done most preferably shortly before harvest for rescuing usable photosynthates from the mother plant that would otherwise end up as field trash instead of incorporation into the daughter cells and plant of the next generation.

The trehalose or trehalose derivative molecules can also be applied at planting or at other times during the growth of the crop plant. This earlier application results in a healthier crop plant, less prone to disease and early decay toward death. Moreover early application of trehalose to certain plants for example, potatoes, results in a plant with less reducing sugar content. Plants with high reducing sugar content can result in a potentially unhealthy situation when crop plant produce is fried in hot oil, for example for potato chips etc. Moreover, the exogenous signaling molecule(s) not only enhance yield but also enhance the apparent health of the plant and healthiness of processed foods if applied in the earlier stages of crop plant growth.

2. Description of the Prior Art

Trehalose is a disaccharide consisting of 2 linked glucose molecules, which is widely produced by plants, insects, and other organisms. It is produced abundantly by certain insects and a few plants, but is present at only trace amounts in most plant species. Until recently, its primary known biological activity was to act as a cryoprotectant when present at relatively high natural abundance in cells of certain organisms, or as an addition during cryopreservation procedures. However, in recent years it has emerged that trehalose and/or its related forms act as an extremely potent signaling molecule in plants, even though present at very low abundance. A form of trehalose functions as a central coordinating regulator of carbohydrate production and flow in plants. In part, it signals carbohydrate availability to promote growth or accumulation of reserves. It also suppresses activity of the kinase SnRK1, thus reducing a key factor that limits growth.

A prior published patent application US 2010/0024066 describes the use of trehalose -6-Phosphate Synthase to modulate plant growth. The patent application presents a background section which indicates that the trehalose is a widespread disaccharide, occurring in bacteria, fungi, insects and plants.

In most cases, trehalose synthesis is a two-step process in which trehalose -6- phosphate Synthase (TPS) synthesizes trehalose -6- phosphate (T6P) followed by dephosphorylation to trehalose by T6P phosphatase (TPP). Although in most plants trehalose is hardly detectable, multiple homologues of both TPS and TPP genes are present. European Patent EP 0901527 discloses the regulation of plant metabolism by modifying the level of T6P. More specifically, the European Patent describes an increase in yield of plants by increasing the intracelluar availability of T6P.

The model described above is a one-way path of metabolism in plants:

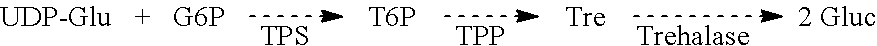

1) UDP-Glucose and Glucose-6-phosphate (G6P) are combined to form trehalose 6-phosphate (T6P) by the enzyme trehalose phosphate synthase (TPS)

2) T6P is de-phosphorylated to Trehalose (Tre) by the enzyme trehalose phosphate phosphatase (TPP)

3) Trehalose is broken down into 2 glucose molecules by the enzyme Trehalase

The European Patent EP0901527 indicates that levels of T-6-P may be influenced by genetic engineering of an organism with gene constructs capable of influencing the level of T-6-P or by exogenously supplying compounds capable of influencing such level, although examples of such exogenous compounds are not mentioned or described.

According to the model presented above, exogenous application of Trehalose to plants may be expected to increase accumulation of T6P by feedback inhibition of TPP. It has been noted that in the absence of available carbon, T6P accumulation can inhibit growth of Arabidopsis seeds (Schluepmann, et al. Plant Physiology, June 2004, Vol. 135, pp. 879-890).

3. Identification of Objects of the Invention

A primary object of the invention is to provide a method and composition for enhancing the productivity and growth of plants for agriculture.

Another object is to provide a method for increasing the productivity of agriculture plants even where the plants are maturing and growing old.

Another object is to provide a method and composition to enhance the productivity and growth of crop plants living under harsh environmental stresses.

Another object is to provide a method and composition to enhance the productivity and growth of crop plants, by more complete transfer of whatever useful photosynthates and/or photosynthate derivatives that are left in the mother plant or even the senescing corpse of the mother plant to the “daughter” seed or other economic portion of the daughter plant growing on the mother plant;

Another object is to provide a method and composition to enhance the productivity, growth and biomass of crop plants, by preventing loss of photosynthate or photosynthate derivatives, from the seed or other “daughter” economic portion of the plant, to the “mother” plant during the growing season;

Another object is to provide a method and composition to enhance the productivity and growth of crop plants, by preventing loss of photosynthate or photosynthate derivatives, from the seed or other “daughter” economic portion of the plant, to the “mother” plant during the growing season, especially under various forms of stress to the mother plant, whether abiotic or biotic;

Another object is to provide a method and composition to mitigate cell death in a plant;

Another object is to provide a method and composition to increase production of ABA and/or ethylene in a plant;

Another object is to provide a method and composition to increase plant resistance to insects and pests;

Another object is to provide a method and composition for use at any time during the growth of the mother plant to increase as full a compliment as possible of photosynthate delivery to the daughter embryo and storage organs of same;

Another object is to provide a method and composition for, at any time during the growth of the mother plant, enhancing acquisition of photosynthates of all and any cells including meristematic cells for increased performance of all and any cells including stem cells;

Another object of the invention is to provide a method and composition to prevent excessive accumulation of photosynthates in temporary storage organs such as the leaves and stems of the mother plant, and transfer of these into harvestable storage organs of the plant;

Another object of the invention is to provide a method and composition to reduce the negative feedback of excessive photosynthates residing in temporary storage organs like the leaves and stems of the mother plant;

Another object of the invention is to provide a method and composition to enhance the vigor of all plant cells by adequate accumulation of photosynthates for optimal and maximum growth of all cells including stem cells;

Considering the sheer amount of research into enhancing “food” production, there is a continued and unfulfilled need to improve crop plant productivity, far beyond the current level of knowledge.

### SUMMARY OF THE INVENTION

The objects identified, along with other features and advantages of the invention are incorporated in a method and composition for growing plants, especially crop plants, but not limited to crop plants, to be more productive by more completely and effectively using the photosynthates and/or the photosynthates accrued in the mother plant, by transferring same to all cells including stem cells and transferring same to the seed or other economic portion of the forming “daughter” plant or storage organs associated with the developing daughter plant.

It has been discovered that certain “signaling” molecules can enhance crop yield by transferring more or even most completely, photosynthates or photosynthate derivatives, from what is an essentially the “corpse” of the senescing mother plant to the “daughter” embryo and embryo storage components, even as late as just shortly before harvest. Moreover, if these particular signaling molecules are applied earlier in the development of the crop and additionally before harvest as a “last chance” scenario, prevention of loss of apparent yield can be overcome, with near complete transfer of photosynthates or photosynthate derivatives to the growing embryo and embryo “food” storage anatomy. Even earlier application of these signaling molecules during development of the crop can beneficially transfer photosynthate not only for enhanced yield or harvest but also a healthier mother plant and healthier food produce.

Exogenous application to a plant of signaling molecules such as trehalose and trehalose derivatives scavenges photosynthates that would otherwise be lost in the senescing corpse of the mother plant rather than be incorporated into the daughter embryos or storage organs of the small and juvenile daughter plants growing on the mother plant. Moreover, the signaling trehalose molecules are applied exogenously at any time before sowing, during sowing or during plant establishment and/or during any of the stages of the growth of the mother plant. Earlier application of the signaling molecules results in enhanced health and vigor of the mother plant with concomitant healthier food produce especially as related to excesses of reducing sugars in the composition of the food produce from the mother plant. The health benefit to the mother plant can be effective even where its seeds are treated prior to planting.

### DESCRIPTION OF THE INVENTION

Traditionally, the concept of affecting crop plant growth is often limited to the beginning of crop establishment, continuing until the economic portion of the crop is rather well developed, after which the crop is considered to senesce (that is, to grow old) and “prepare' itself for maturation and dissemination of the seed etc. Moreover, though, as the growing season progresses, stress of various types can also set in whereby varying levels of autophagy can scavenge photosynthates from the “daughter”, i.e., seed and similar harvestable portions of the crop. (autophagy is the maintenance of plant nutrition by metabolism breakdown of certain bodily tissues)

These scavenged photosynthates from the daughter embryos and storage organs thereof, are often returned to the mother plant as a “perceived” necessity to retain “fitness” of the mother plant to complete the gestation cycle of the daughter plants especially under varying levels of abiotic or biotic stress. The result of this autophagy is a “reduction” or loss in yield at harvest. This loss or apparent reduction in anticipated yield is very often manifested in crops, and mostly represents an imbalance of hormones and inadequate signaling for delivery of photosynthates to the daughter embryos and storage organs.

A preferred implementation of the invention addresses one or more deficiencies of the prior art and furthermore results in achieving one or more of the objects identified above. According to the invention an aqueous solution that includes trehalose or a trehalose derivative is exogenously applied in small concentrations to crop plants to effect a substantial amount of photosynthate transfer close to the end of the growing season that would be totally lost to the trash heap of the mother plant corpse instead of accumulation into the young and juvenile daughter embryos and storage organs of the daughter embryos. Moreover, the signaling sugar treatment also prevents autophagy of the very juvenile embryos and storage organs of the embryos, being subjected to a perceived need for photosynthesis products (i.e., photosynthates) required by the mother plant to complete the reproductive cycle of the attached daughter plants. In contrast to perennial crops (e.g., fruits, nuts) in which the mother plant does require additional reserves for the succeeding years, the photosynthates in annual plants (corn, potatoes, soybeans, etc.) can be completely and irrevocably transferred to the attached daughter plants in a most complete fashion even to the point of leaving nothing but a mostly cellulose corpse of the mother plant. In this manner, yield of annuals at harvest time are hugely increased, thus maximizing the efficiency of crop production as regards already formed readily usable photosynthates.

Moreover, the exogenously applied trehalose signaling molecule can be applied earlier during the growth of the mother plant which results in large positive influences on yield and health of the mother plant and healthiness of the food produced by the mother plant. This can be accomplished by altering the characteristics of production, metabolism, and trafficking of sugars in the plant, mediated in part by the plant kinases SnRK1 and TOR, which can be regulated by T6P and/or trehalose.

The disease suppressing effect of the signaling molecules is exemplified with a highly significant reduction of zebra chip disease in potatoes. The healthier food is also exemplified by decreased reducing sugar content of signaling sugar-treated potatoes. A visual examination of untreated vs treated potatoes fried in hot oil shows the benefit of applying trehalose to two growing potato plants.

Examples are presented below showing the enhanced effects on crop yield by application of trehalose.

### EXAMPLE 1

Field Corn, cultivar Asgrow 7371, was twice treated foliarly before harvest with an aqueous solution of trehalose at the rate of 100 grams of trehalose per acre, at 4 weeks after the V16 stage of growth, and once again foliarly at the same rate at 5 weeks after the V16 stage of growth. Yields were increased by up to 125% by treatment of trehalose (Table 1).

TABLE 1
Effect of a foliar application of trehalose @ 100 grams per acre, 4 weeks
after the V16 stage of growth and again at the same rate, 5 weeks
after the V16 stage of growth on yield characteristics, Cultivar 7371.
Yield of field corn (bushels per acre)

| Control Untreated | 103 bu/acre |
|---|---|
| Treated 4 and 5 wks after the V16 stage | 231 bu/acre |
| of growth | |
| T test of mean of treated vs control, p= | 0.00058 |

Weight of 1,000 kernels (grams)

| | |
|---|---|
| Control Untreated | 288 grams |
| Treated 4 and 5 wks after the V16 stage | 368 grams |
| of growth | |
| T test of mean of treated vs control, p= | 0.00018 |

### EXAMPLE 2

Field corn, Cultivar Dekalb C6805, was treated foliarly with an aqueous solution of trehalose at the rate of 100 grams per acre, either at the V16 stage of growth or 3 weeks before the V16 stage of growth, in southern Texas. Field corn yields were increased with this cultivar from 155 bushels per acre to an unprecedented 337 bushels per acre for this locale, characterized by hot, windy climate and poor soils and high levels of pests including disease and insects. Seed weights of the corn kernels were increased.

TABLE 2
Effect of a foliar application of trehalose @ 100 grams
per acre, at either the V16 stage of growth or 3 weeks
before the V16 stage of growth, Cultivar Dekalb C6805
Yield of field corn (bushels per acre)

| | |
|---|---|
| Control Untreated | 155 |
| Trehalose-treated at the V16 stage of | 311 |
| growth | |
| Trehalose-treated, 3 wk prior to V16 | 327 |
| growth stage | |
| T test at V16 vs control, p= | 0.00000024 |
| T test at 3 wk prior to V16 vs control, | 0.0000060 |
| p= | |
| T test V16 vs 3 weeks prior, p= | 0.024 |

Weight of 1,000 kernels (grams)

| | |
|---|---|
| Control Untreated | 261 |
| Trehalose-treated at the V16 stage of | 286 |
| growth | |
| Trehalose-treated, 3 wk prior to V16 | 294 |
| growth stage | |
| T test at V16 vs control, p= | 0.023 |
| T test at 3 wk prior to V16 vs control, | 0.003 |
| p= | |
| T test V16 vs 3 weeks prior, p= | 0.092 |

### EXAMPLE 3

Potato, cultivar Eva, had increased yields with either an exogenous application of an aqueous solution of trehalose at the rate of 100 grams per acre applied foliarly at 4 weeks before harvest (Table 4). If applied at 4 weeks before harvest there was sufficient time in crop development to suppress reducing sugar concentrations for a healthier food product (Table 5).

TABLE 4
Yield of Eva potato variety treated with 4 rates of trehalose as foliar
application 4 weeks before harvest.

| | Treatment pounds per graded size | | | | |
|---|---|---|---|---|---|
| | #4 | #3 | #2 | #1 | Total |
| Control | 0.0 | 6.8 | 6.8 | 0.8 | 14.4 |
| Trehalose-25 g | 0.0 | 8.6 | 7.2 | 1.1 | 16.9 |
| Trehalose-50 g | 0.0 | 8.3 | 7.0 | 0.9 | 16.2 |
| Trehalose-100 g | 0.4 | 8.4 | 7.4 | 0.8 | 17.0 |

Size distribution:
#5 = >16 ounces,
#4 = >10 ounces,
#3 = >6 ounces,
#2 = >4 ounces, and
#1 = 0 to 4 ounces.

### EXAMPLE 4

Potatoes, cultivar Eva in Pennsylvania, were treated either 4 or 2 weeks before harvest with a foliar application of trehalose at the rate of 100 grams per acre. The potatoes were harvested and shipped to College Station, Texas for analysis of reducing sugars. During the more active growth period 4 weeks before harvest, the reducing sugars were decreased in the potato tubers; closer to the end of the growing season and end of the crop plants, the sugars appeared to have been more directly routed into the tubers. (Table 4).

TABLE 4
Effect of foliar treatments of trehalose, either 4 or 2 weeks before
harvest on the reducing sugar content of the potato tubers, n = 16

| | Reducing Sugar Content of Tubers | |
|---|---|---|
| | (absorbance at 570 nm) | |
| | 4 weeks before | 2 weeks before |
| Treatment | Harvest | Harvest |
| Control Untreated | 0.217 ± 0.15 | 0.200 ± 0.08 |
| Trehalose @ 100 | 0.125 ± 0.03 | 0.211 ± 0.12 |
| grams/acre | | |
| T test control vs | 0.029 | NS |
| treated p= | | |

### EXAMPLE 5

Potatoes, cultivar Snowden in Wisconsin, were treated either 4 or 2 weeks before harvest with a foliar application of trehalose at the rate of 100 grams per acre. The potatoes were harvested and shipped to College Station, Tex. for analysis of reducing sugars. There was a decrease in reducing sugar content, inversely proportional to the dose of trehalose applied to the plants. See the effect of trehalose application rate on content of reducing sugars in potato tubers as shown in Table 5 presented below.

### EXAMPLE 6

Sugar Beets were foliarly treated with Trehalose at the rate of 300 grams per acre in Yuma Colo. The treatment transferred nearly half an extra ton of sugar per acre to the beets; moreover, there was a decided reduction in % SLM with the sugar signaling just 2 weeks before harvest (Table 6).

TABLE 6
Effect of a foliar treatment of the aqueous solution of Trehalose @
300 grams per acre on sugar beet yield and quality.

| | |
|---|---|
| | Trehalose @ 300 g/a Foliar, 2 weeks |
| Control Untreated | before harvest |

Sugar Beet yield (tons per acre)

| | |
|---|---|
| 27.79 | 28.4 |

Percent Sugar

| | |
|---|---|
| 15.83% | 17.23% |

Pounds of Sugar per acre

| | |
|---|---|
| 8797 | 9770 |

Percent SLM

| | |
|---|---|
| 1.85 | 1.22 |

EXAMPLE 7

Sugar Cane, grown in southern Texas was treated 4 weeks before harvest with an aqueous solution of Trehalose at the rate of 450 grams per acre, gave an extra 897 pounds of sugar from sugar cane production.

TABLE 7
Effect of trehalose @ 450 grams per acre on increase in
lb of sugar per acre from sugar cane

| | |
|---|---|
| Control Untreated | 0 |
| Trehalose @ 450 g/a Foliar, 4 weeks | 897 lb |
| before harvest | |

### EXAMPLE 8

Wheat, grown in Ontario Canada, was treated foliarly with an aqueous solution of trehalose at the rate of 100 grams per acre, 4 weeks before harvest.

TABLE 8
Effect of foliar application of
Trehalose on increase in yield of winter wheat

| | |
|---|---|
| Control Untreated | 0% |
| Trehalose @ 100 g/a Foliar, 4 weeks | 9.5%, highly significant |
| before harvest | |

### Mechanisms and Modes of Action

As described above current models of trehalose synthesis in plants suggest there is a one-way path of metabolism:

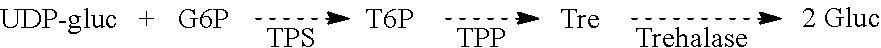

1) UDP-Glucose and Glucose-6-phosphate (G6P) are combined to form the potent signal molecule trehalose 6-phosphate (T6P) by the enzyme trehalose phosphate synthase (TPS)

2) T6P is de-phosphorylated to Trehalose (Tre) by the enzyme trehalose phosphate phosphatase (TPP) 3) Trehalose is broken down into 2 glucose molecules by the enzyme Trehalase

According to this one way model, application of Trehalose to a plant might not be expected to increase production of T6P. However, biological activity from application of trehalose to a plant may result at least in part from increased T6P inside the plant after application of trehalose to the plant. This may be due to a feedback inhibition on TPP activity by the higher amounts of added Tre, or it may be due to conversion of Tre to T6P by a currently unknown enzyme activity or kinase activity.

An activity of T6P/Tre of primary importance in plants is its influence on sugar-related signaling. As such, Tre/T6P exercises a central, controlling role in plant growth and development including germination, growth, differentiation, flowering, fruit/grain formation, and carbohydrate storage. Trehalose also inhibits starch breakdown, leading to increased starch accumulation. This may be a basis for observed increases in yield of starch-storing crops such as potato and corn.

The increased yield in a plant when Trehalose is applied to it may be due to the trehalose molecule itself or other possible derivatives of T6P or trehalose as active principles from application of trehalose. If trehalose application to a plant increases abundance of T6P in the plant, then known plant responses to T6P may result as listed below.

Here are the possible biochemical mechanisms on a plant resulting from the application of Trehalose:

Trehalose/T6P acts as potent signals of sugar status in the plant, which can alter photosynthate partitioning, primary carbon fixation, carbohydrate retention, and/or growth of the plant;

Trehalose/T6P increases production of abscisic acid (ABA) and/or ethylene in the plant, which advances or improves the ripening process of fruits, grains, or other plant products;

Trehalose/T6P increases production and storage of sugars in sugar beets, sugar cane, and other crops;

Trehalose/T6P increases production and inhibits breakdown of starch, increasing retention of stored carbohydrate in potatoes and other crops; and/or

Trehalose/T6P induces flowering by acting as a sugar status signal preparing the plant to enter floral transition.

1. (canceled)

2. (canceled)

3. (canceled)

4. (canceled)

5. (canceled)

6. (canceled)

7. (canceled)

8. (canceled)

9. (canceled)

10. (canceled)

10. (canceled)

11. (canceled)

12. A method for enhancing yield of crop plants comprising the steps of
preparing a molecular signaling solution including Trehalose (TRE) without acidic additives and water where said Trehalose functions to enhance plant sugar-related signaling to increase plant yield, applying the molecular sugar-related signaling solution to the foliage of the crop plants or into the soil in which the crop plants are growing, or into seeds prior to planting,
wherein said molecular sugar-related signaling solution is applied at a rate of from 10 to 500 grams of Trehalose per acre, said rate being insufficient to act as an agent for significant carbon skeleton or energy component in the plants.

13. The method of claim 12,
wherein application of Trehalose to said crop plants increases production of Trehalose 6-phosphate (T6P) inside the plant, with the result that TRE/T6P inside the plant functions as a central signaling role for controlling plant growth and development in the plant.

14. The method of claim 12
wherein application of Trehalose solution to said crop plants inhibits starch breakdown with the result that increased starch accumulation occurs which produces increased yield of starch-storing crops potato and corn.

15. The method of claim 13
wherein TRE/T6P inside the plant induces flowering by acting as a sugar status signal preparing the plant to enter floral transition.

16. the method of claim 12
wherein said molecular signaling solution is applied to said crop plants at the end of the growing season for the crop plants.

17. The method of claim 12
wherein said molecular signaling solution is applied at any time during the growth of the plants from the beginning of seed germination until completion of crop development.

18. The method of claim 12
wherein said molecular sugar-related signaling solution applied to the crop plant increases the level of T6P in the plants thereby enhancing near complete photosynthate transfer from a mother plant in annual crop plants to the juvenile daughter embryo and storage organs of the daughter plant growing on the mother plant.

19. A method of increasing yield of field corn plants comprising the steps of
preparing a molecular signaling solution including Trehalose (TRE) and water but without acidic additions of vinegar or citric acid,
applying said molecular signaling solution to the leaves of said field corn plants at the rate of about 100 grams of Trehalose per acre at or before about V16 stage of growth,
wherein said Trehalose functions to enhance plant sugar-related signaling to increase plant yield, but said rate of 100 grams of Trehalose per acre is such that Trehalose does not act as an agent for significant carbon skeleton in the plant or as an energy component in the plant.

20. A method of increasing the yield of potato plants comprising the steps of
preparing a molecular signaling solution including Trehalose (TRE) and water but without acidic additions of vinegar or citric acid,
applying said molecular signals solution at the rate of about 100 grams per acre to the potato plants at about 2 weeks before harvest,
wherein said Trehalose functions to enhance sugar-related signaling to insure plant yield, but said rate of 100 grams of Trehalose per acre is such that Trehalose does not act as an agent for significant carbon skeleton in the plant or as an energy component in the plant.

21. A method of reducing sugar concentration of potato plants comprising the steps of
preparing a molecular signaling solution including Trehalose (TRE) and water but without acidic additions of vinegar or citric acid,
applying said molecular signaling solution at the rate of about 100 grams per acre to the potato plants at about 4 weeks before harvest,
wherein said Trehalose functions to enhance sugar-related signaling to insure plant yield, but said rate of 100 grams of Trehalose per acre is such that Trehalose does not act as an agent for significant carbon skeleton in the plant or as an energy component in the plant.

22. A method of increasing the yield and quality of sugar beet plants comprising the steps of
preparing a molecular signaling solution including Trehalose (TRE) and water but without acidic additions of vinegar or citric acid,
spraying said molecular signaling solution to the leaves of said sugar beet plants at the rate of about 300 grams per acre about 2 weeks before harvest,
wherein said Trehalose functions to enhance sugar-related signaling to insure plant yield, but said rate of 300 grams of Trehalose per acre is such that Trehalose does not act as an agent for significant carbon skeleton in the plant or as an energy component in the plant.

23. A method of increasing the yield of sugar cane plants comprising the steps of
preparing a molecular signaling solution including Trehalose (TRE) and water but without acidic additions of vinegar or citric acid,
spraying said Trehalose solution to the leaves of said plants at the rate of about 450 grams per acre about 4 weeks before harvest,
wherein said Trehalose functions to enhance sugar-related signaling to insure plant yield, but said rate of 450 grams of Trehalose per acre is such that Trehalose does not act as an agent for significant carbon skeleton in the plant or as an energy component in the plant.

24. A method of increasing the yield of wheat comprising the steps of
preparing a molecular signaling solution including Trehalose (TRE) and water but without acidic additions of vinegar or citric acid,
spraying said Trehalose solution to the wheat plants at the rate of about 100 grams per acre at about 4 weeks before harvest,
wherein said Trehalose functions to enhance sugar-related signaling to insure plant yield, but said rate of 100 grams of Trehalose per acre is such that Trehalose does not act as an agent for significant carbon skeleton in the plant or as an energy component in the plant.
